(19) United States
(12) Patent Application Publication
(10) Pub. No.: US 2006/0224440 A1
(43) Pub. Date: Oct. 5, 2006

(54) Systems and methods for determining process cycle efficiency in production environments

(75) Inventor: Sudhendu Rai, Fairport, NY (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/094,231

(22) Filed: Mar. 31, 2005

(51) Int. Cl. G06F 11/34

(52) U.S. Cl. 705/11

(57) ABSTRACT

A system and method whereby the process cycle efficiency (PCE) of individual workflows may be determined using a combination of data collection tools, data manipulation routines, and statistical analysis methods. The individual workflows may be statistically analyzed to determine the PCE for the overall production process. Changes in performance for on set of workflows over a period of time may be determined by statistical hypothesis testing.

Cross-reference is made to co-pending, commonly assigned applications, including: U.S. application Ser. No. ______, filed ______, entitled “Systems and Methods For Capturing Workflow Information”, (Attorney Docket No. 20041013-US-MP); and U.S. application Ser. No. ______, filed ______, entitled “A Metric to Measure Labor Traveling Efficiency In the Executing a Production Workflow and a Method and System To Measure It”, (Attorney Docket No. 20041014-US-MP); which are herein incorporated by reference.

### BACKGROUND

This invention relates in general to automated techniques for organization management and, more particularly, to systems and methods for determining the process cycle efficiency (PCE) for a production process having individual workflows.

Lessons learned from lean manufacturing and Sigma six techniques have improved the efficiency of both automated and manual processes. PCE is a critical measure of effectiveness of production workflows. PCE is defined as the ratio of the value added time spent in producing a job to the total time spent in producing the job. PCE is directly correlated with several measures of production efficiency, such as work-in-progress and customer satisfaction.

The current method of determining process cycle efficiencies in production environments (and especially print shops) is highly manual. In situations where there is significant variability in routing and production specifications, PCE values are difficult to measure and interpret.

In a conventional production print shop workflow, there may be a number of different possible processes, or workflows, through which any particular print job may be produced. Each workflow may comprise a number of events, an event being some level of production at one of a series of workstations. By entering job related information and maintaining records regarding aspects of each event, such as start time, completion time and the resources used to complete the job, it may be possible to determine, and perhaps improve, the efficiency of the workflows.

Most production environments utilize manual data collection methods for collecting workflow related information. This information may include job identification information, operator information, workstation information and/or quantity information. In such manual data collection, production efficiency is difficult to maintain because manual entry of data is time consuming and prone to error.

Technological advances, such as PC based collection devices and wireless handheld barcode scanners have introduced automation to the data collection methods.

### SUMMARY

Although there has been a significant improvement in data collection methods, it is important to realize the collection of data in itself does not improve the efficiency of the workflow. Techniques learned from both lean manufacturing processes and Six Sigma may be applied to workflow processes, specifically print production workflows, to improve the PCE, and as a result the profitability of the production environment.

Exemplary embodiments of systems and methods may provide automated determination of process cycle efficiency (PCE) of individual workflows and the PCE for an overall production process. Exemplary embodiments may include: capturing event data within a workflow process; storing the data within a database; determining a PCE for each workflow; and statistically analyzing each workflow to determine a PCE for the overall production process.

Although the exemplary embodiments disclosed herein relate to print shop environments, it should be understood that the systems and methods may be used in conjunction with other environments having manual and/or automated workflows, and that the exemplary embodiments are not limiting.

### BRIEF DESCRIPTION OF THE DRAWINGS

Various exemplary embodiments are described in detail, with reference to the following figures, wherein:

FIG. 1 illustrates an exemplary flow diagram of a print production workflow;

FIG. 2 is an exemplary block diagram of a system by which workflow information from distributed workstations may be captured; and

FIG. 3 illustrates a process by which the efficiency of the workflow may be determined.

### DETAILED DESCRIPTION OF EMBODIMENTS

The following detailed description of exemplary embodiments is particularly directed to systems and methods for automated determination of a process cycle efficiency (PCE) for individual workflows and a PCE for the overall production process. The exemplary embodiments described below are particularly directed to print shop environments. Thus, the following detailed description makes specific reference to workflows wherein the workstations include Xerographic devices, such as printers and copiers. However, it should be understood that the principles and techniques described herein may be used in other environments such as mailrooms, document scanning and repository centers and other services operations involving equipments that require manual handling.

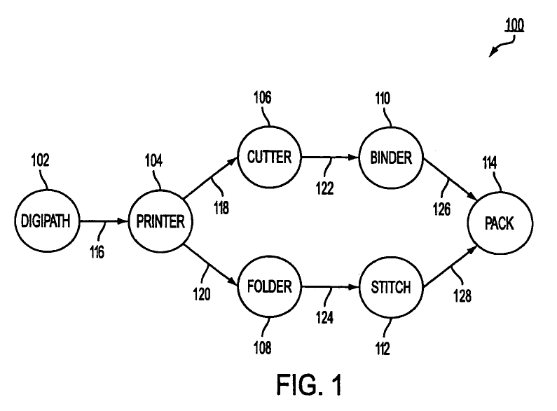

FIG. 1 illustrates an exemplary workflow schematic, in which each node 102-114 represents a workstation, and the directed arcs 116-128 may determine the flow of the job from one workstation to another. The problem being addressed is how to determine the efficiency of not only one particular workflow, but of multiple workflows in the print shop environment that may or not be dependent upon each other.

In the workflow of FIG. 1, a typical print production workflow may entail the tasks of: creating the print job at a Digipath workstation 102, directing 116 the print job to a Printer workstation 104, directing 118 some quantity of the output of the Printer workstation 104 to a Cutter workstation 106. The output of the Cutter workstation 106 may be directed 122 to a Binder workstation 110, which may then direct 126 the bound print job to a Pack workstation 114. In parallel with the cutting, binding and packing of some of the print job output, a portion of the Printer workstation 104 output may be directed 120 to a Folder workstation 108. The folded output may then be directed 124 to a Stitching workstation 112, after which the stitched output may be sent 128 to a Packing workstation 114.

At each workstation 102-114, certain types of information may be of interest and may be collected. A set of information types collected regarding to the production at each workstation may include, but is not limited to:

JobId: A unique identifier that captures the information on the job itself;

StationID: a unique identifier that identifies the workstation that is performing the task;

OperatorID: A unique identifier that identifies the operator who is working on the job at the particular station;

Eventld: One of a set of event types that includes identification of the event (e.g. Arrival, Due, Completion, Start, Stop, Interrupt, Restart, etc.); and

Quantity: The quantity of work product to be produced at the particular StationID by the particular OperatorID for that particular JobId.

Accurate determination of the PCE for individual workflows as well as the PCE for the overall production process may require accurate information regarding production workflow information. A system and method of capturing production workflow information, disclosed in a co-pending application with Attorney Docket No. 20041014-US-MP, may include RFID tags, RFID readers, audio input devices and speech recognition technologies to gather production workflow data. Each RFID reader and audio input device may be connected to a computer network allowing tracking of production jobs without geographic limitations.

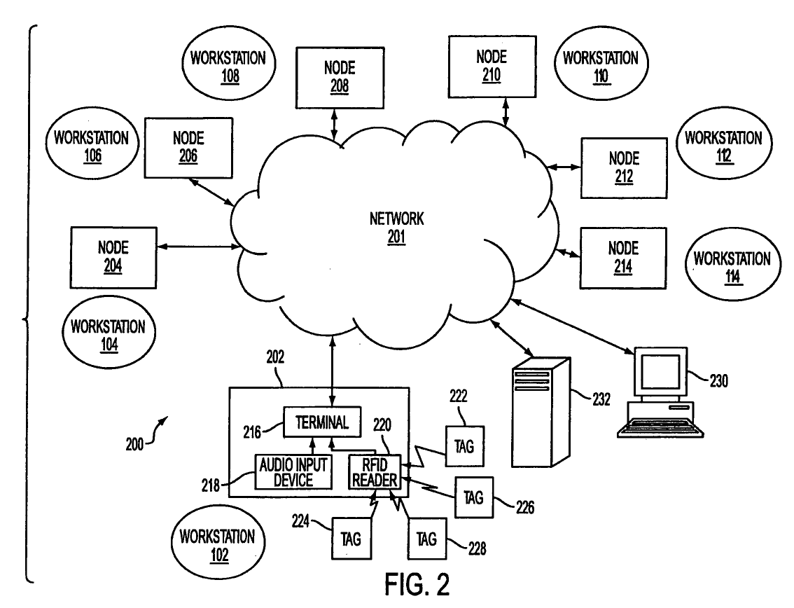

FIG. 2 illustrates a high-level block diagram of an exemplary system 200 for capturing production workflow information across a network 201. Tracking nodes 202-214 located in close proximity to workstations 102-114 may each comprise a communications terminal 216, an RFID reader 220 and a voice input terminal 218. The voice input terminal may collect information not conducive for storing via an RF tag, such as quantity of production output and the next node in the workflow process.

The communications terminal 216 may comprise a computer or other hardware device capable of communicating with the network 201, and may transmit the data captured by the RF reader 220 and the voice input device 218 to a database server 232 on the computer network 201.

The event data may be stored as records in the database server 232. A computer 230 comprising hardware and software capable of accessing the database server 232 may perform the measuring and statistical methods discussed in detail below. Database software, server hardware and computers capable of implementing coded instructions are known to those knowledgeable in the field of information systems and are non-limiting examples.

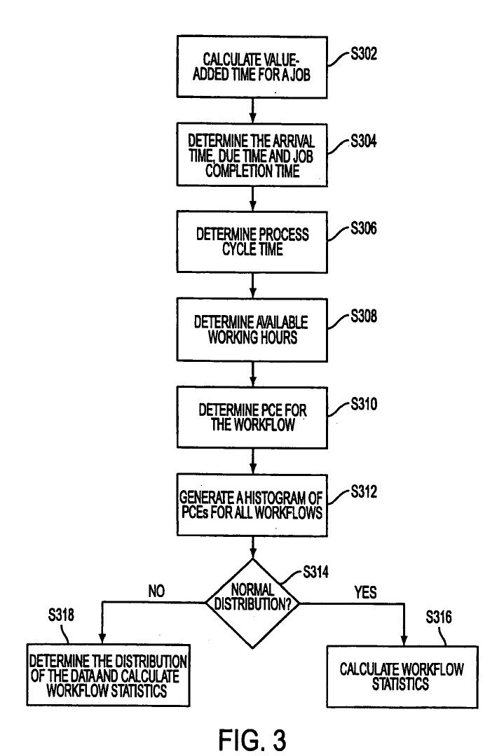

FIG. 3 illustrates an exemplary method by which the computer 230, by accessing records stored on the database server 232, may determine the PCE of at least one workflow in the print shop and the overall efficiency of the print shop environment. Although the steps disclosed may be directed towards events and workflows particular to print production environments, the methods disclosed are exemplary and non-limiting.

At step S302, the value-added time associated with each job for a particular workflow may be determined. The value added time may be the sum of the time intervals between each start and stop event associated with each job. This value may be the sum of all time actually worked producing output for the job.

At step S304, a query may be performed that determines the arrival time, due time and job completion time for each job.

At step 306, the process cycle time may be determined, and may be defined as the interval of time between the job arrival time and the job completion time and then subtracting out the time the shop was unavailable for production. Shop unavailability may be determined by a shop schedule that may be maintained on database 232 for each production environment. Further editing may be done for the specific production operation to take into account other special holidays or circumstances. Based upon the information captured, the available working hours between any two time intervals may be determined S308.

At step S310 the PCE for a particular workflow may be calculated as the ratio of the value-added time to the process cycle time. At step 312, a histogram of the PCEs for all jobs may then be plotted to determine whether or not the workflow follows a normal distribution curve.

At step S314 the distribution of the PCE may be analyzed. If the distribution is normal, various statistical properties may be calculated at step S316, and may include the mean and confidence intervals of the population. If the PCE distribution is not normal, further analysis may be performed at step S316 to determine the best distribution curve that fits the data. Subsequent to determining the distribution curve of the data, various statistical parameters of the distribution, such as mean, median, and confidence intervals may be determined.

The methods disclosed above may be used to compare the PCE of a given production environment with other benchmark environments. The method may also be used as a basis of comparison upon redesign of the workflow. An exemplary method may perform automatic statistical hypothesis testing on one or more PCE distributions to statistically compare a PCE determined automatically for one set of workflows with the PCE of the enviroment at some later date and time to determine if the PCE of the workflow has changed.

It will be appreciated that various of the above-disclosed and other features and functions, or alternative thereof, may be desirably combined into many other different systems or applications. Also, various presently unforeseen or unanticipated alternatives, modifications or improvements therein may be subsequently made by those skilled in the art and are also intended to be encompassed by the following claims.

What is claimed is:

1. A system for determining process cycle efficiency within a production environment, comprising:
a database;
a computer in communication with the database, the computer including a program memory; and
program instruction code stored in the program memory, the program instruction code operating to determine a process cycle efficiency of at least one job workflow and a process cycle efficiency for all workflows.

2. The system of claim 1, wherein the database comprises workflow information.

3. The system of claim 2, wherein the workflow information comprises at least one of JobId information, OperatorId information, StationId information, Eventld information and timestamp information, wherein EventId information further includes at least one of arrival time, job start time, job stop time, and completion time.

4. The system of claim 3, wherein the database further comprises date and time information regarding an operating schedule of the production environment.

5. The system of claim 1, wherein the program instruction code comprises program code configured to determine a value-added time associated with at least one job, the value-added time being a sum of all time spent to output the at least one job.

6. The system of claim 5, wherein the program instruction code further comprises program code configured to:
determine a process cycle time of the at least one workflow, the process cycle time being a function of a job arrival time, a job completion time and an operating schedule of the production environment.

7. The system of claim 5, wherein the program instruction code further comprises program code configured:
to determine the process cycle efficiency based upon a ratio of the value-added time to the process cycle time.

8. The system of claim 3, wherein the program instruction code further comprises program code configured to determine an available working time between a first time and a second time, the available working time comprising an amount of time between the first time and the second time that the production environment is available for production.

9. The system of claim 3, wherein the program instruction code further comprises program code configured to determine statistical parameters.

10. The system of claim 3, wherein the program instruction code further comprises program code configured to draw a histogram of the process cycle efficiency for all jobs.

11. The system of claim 1, further comprising at least one node in communication with the database, the at least one each node comprising an RFID reader, wherein the at least one node is configured to transmit workflow information to the database.

12. The system of claim 1, wherein the production environment comprises at least one Xerographic workstation.

13. A production print shop comprising the system of claim 1.

14. A method of determining a process cycle efficiency of an environment including at least one workflow, comprising:
maintaining a database of captured workflow information;
determining a value-added time associated with at least one job, the value-added time being a sum of all time spent outputting the at least one job;
determining a process cycle time of the at least one job, the process cycle time being a function of the job arrival time, the job completion time and a work schedule of the environment; and
determining a process cycle efficiency of the workflow.

15. The method of claim 14, further comprising:
capturing at least one of JobId information, OperatorId information, StationId information, EventId information and timestamp information, wherein EventId information further comprises at least one of arrival time, job start time, job stop time and job completion time.

16. The method of claim 14, further comprising plotting a histogram of the process cycle efficiencies for at least one workflow.

17. The method of claim 14, wherein determining the process cycle efficiency of the workflow comprises calculating the ratio of the value-added time to the process cycle time.

18. The method of claim 14, further comprising:
determining a distribution curve of a plurality of process cycle efficiencies of the at least one job; and
calculating mean, median and confidence intervals of the determined distribution curve.

19. The method of claim 14, further comprising:
statistically comparing the process cycle efficiency for a set of workflows with a process cycle efficiency of the environment at a later time.

20. The method of claim 14, wherein the process cycle efficiency is determined for a workflow including at least one Xerographic workstation.
